(19) United States
(12) Patent Application Publication
(10) Pub. No.: US 2023/0172693 A1
(43) Pub. Date: Jun. 8, 2023

(54) MULTI-AXIS MULTI-ANCHORED IMPLANTS

(71) Applicant: CAO Group, Inc., West Jordan, UT (US)

(72) Inventor: Steven D. Jensen, South Jordan, UT (US)

(73) Assignee: CAO Group, Inc., West Jordan, UT (US)

(21) Appl. No.: 18/162,656

(22) Filed: Jan. 31, 2023

Related U.S. Application Data
(63) Continuation-in-part of application No. 16/917,567, filed on Jun. 30, 2020, now abandoned.
(60) Provisional application No. 63/314,239, filed on Feb. 25, 2022.
(60) Provisional application No. 62/880,399, filed on Jul. 30, 2019.

(51) Int. Cl. A61C 8/00; A61C 13/00

(52) U.S. Cl. CPC A61C 8/00; A61C 13/0004

(57) ABSTRACT

Customized dental implants feature enhanced osseointegrable qualities by manufacturing the implant post with osseointegrable material and preparing a larger post body, including a portion to cover a maximized prepared bone surface, to integrate with a jawbone. Resultant implants are more durable and provide a better fit into the oral cavity. Various implant shapes and designs are disclosed. A dental implant may feature a plurality of bone spikes to serve as anchors for the implant in a patient's mouth. Multiple anchors lessen torques experienced by the implant during use. Ideally, the anchors will also project in different axes to maximize osseointegration and strength of the bond between bone and the implant.

### CROSS-REFERENCES TO RELATED APPLICATIONS

The present invention claims priority as a non-provisional perfection of prior filed U.S. application no. 63/314,239, filed on Feb. 25, 2022 and also as a continuation-in-part of prior filed U.S. application Ser. No. 16/917,567, filed on Jun. 30, 2020 which in turn claims priority to prior filed U.S. provisional application No. 62/880,399 filed on Jul. 30, 2019, and incorporates the all of these applications by reference herein in their entirety.

### FIELD OF THE INVENTION

The present invention relates to the field of dentistry and more particularly relates to a customizable dental implant utilizing a greater osseointegrable area of a patient's jaw in combination with a plurality of anchor points along multiple axes.

### BACKGROUND OF THE INVENTION

One modern dental restorative technique is the use of a dental implant to replace a damaged or diseased tooth. Implants offer convenience over the traditional use of false teeth as they are permanently attached to the jawbone of the patient and do not need to be removed. The patient merely brushes and cares for his or her teeth as usual to also care for the implant. Contemporary dental implants consist of and rely solely on a single titanium single screw that is driven into bone and allowed to osseointegrate into the bone as a complete implant unit. Thereafter, prosthetic attachments, usually comprising an abutment and a permanent prosthetic tooth, are attached to an exposed head of the implant screw and complete the restoration.

There are some marked limitations concerning this single-post technique. The first limitation is that the area adjacent the exposed screw head is comprised of soft tissue, leaving a gap between the prosthetic and the healed soft tissue beneath it. This gap becomes packed with food, bacteria, and debris, and must be constantly cleaned. Otherwise, the tissue surrounding this gap develops periodontal infections over the course of time. The elimination of this gap would reduce such infections.

The second limitation is that implant screws are single axis implants solely comprising a Z-axis and are only osseointegrated on that single axis as well. Contemporary implant theory and practice asks too much for a single screw to accomplish. The biggest problem with the single dental implant screw is that the single screw becomes a single fulcrum attachment point where bigger and wider prosthetics become permanently attached. These prosthetics then act as levers that multiply the forces on a single point implant. These prosthetics then flex the implant back and forth and can, over time, cause the implant to fail. These torques are especially pronounced on interior teeth. At least one instance of prior art requires the creation of an implant that emulates the root structure of a tooth; however, this strategy requires either in implant from a scan of a recently removed tooth or creating a socket in an approximation of said root structure in the bone, which may be difficult to achieve.

The present invention represents a departure from the prior art in several ways. First, the present invention allows for dental implants that are not limited to an osseointegration area defined by an inserted structure such as a single titanium post or fin, which only represents a portion of the total available osseointegrable area. The present invention produces custom implants that are designed to fit an entire exposed bone surface, including any area between the prosthetic restoration and any adjacent bone. The purpose is to maximize the surface area in which the implant will osseointegrate and provide for a fully integrated implant with increased strength and durability because it is integrated over this maximized surface area. Secondly, the present invention is a dental implant that incorporates multiple axes is designed to spread out the osseointegration area into the Cartesian coordinate system comprising X, Y, and Z-axes. In this invention, multiple insertion pins, rods, or screws are utilized to hold the implant firmly in place while healing takes place such that maximum osseointegration occurs as efficiently as possible. These multiple anchor points are positioned to maximize hold in all three Cartesian axes and do not follow normal dental geometry. The use of a plurality of individual spikes can also eliminate the need for precise shapes, other than the formation of a bone box that serves as a seat for the implant and maximizes osseointegration surface area. This strategy departs from the prior art in that the dental implant of the present invention allows for not only a wider osseointegration area which reduces the gap between the implant and adjacent soft tissue, but also allows for the distribution of forces throughout a larger volume of the bone into which the implant has osseointegrated and for a greater osseointegration factor of the implant. This multi-axis design divides the torques placed upon the implant axes to increase the useful life of the implant.

### SUMMARY OF THE INVENTION

In view of the foregoing disadvantages inherent in the known types of dental implants, an improved dental implant may provide an implant body with a plurality of anchors which will have a maximized osseointegrable surface between the implant and the host bone. Maximization of the surface area for osseointegration will ultimately be dependent on several factors which the practitioner will consider, including the health and availability of underlying jaw bone tissue. However, the goal of such maximization is for the implant to cover and occupy, and osseointegrate with the jaw bone in, the same space that the original tooth occupied. As such, when used in this specification, the term “maximization” as used in the specification shall mean that the practitioner will endeavor to expose as much of the underlying bone tissue as possible, this would include and in most cases will exceed a surface area that was previously occupied by a tooth/teeth, and the implant will present a surface area to match that exposure. Such an implant should meet the following objectives: that it be inexpensive to manufacture and be relatively simple and safe to implant, that it sufficiently osseointegrate with patient tissues, that it utilizes a plurality of anchor points to facilitate osseointegration, and that it minimizes gaps that may lead to infection. As such, a new and improved dental implant may comprise an implant body having multiple implant points, including at least one that screws into underlying bone tissue, to accomplish these objectives.

The present invention is designed to utilize osseointegrable materials, such as bone, teeth, artificial bone, artificial teeth, coral, seashells, calcium phosphates, calcium carbonate, calcium phosphate tribasic, calcium phosphate dibasic, calcium phosphate monobasic, porcelains, ceramics, cements, metals, and any other materials that osseointegrate. An embodiment of the present invention utilizes osseointegrable materials capable of forming a hard and durable aggregated mass. An embodiment of the present invention prefers osseointegrable materials in the form of a block; wherein the block is capable of being installed onto a milling machine and machined into a desired shape. A preferred embodiment of the present invention utilizes osseointegrable materials in the form of a block, which is then installed on a milling machine and machined into a form of a customized implant prosthetic.

The more notable features of the invention have thus been outlined in order that the more detailed description that follows may be better understood and in order that the present contribution to the art may better be appreciated. Additional features of the invention will be described hereinafter and will form the subject matter of the claims that follow.

Many objects of this invention will appear from the following description and appended claims, reference being made to the accompanying drawings forming a part of this specification wherein like reference characters designate corresponding parts in the several views.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in several ways. Also, it is to be understood that the phraseology and terminology employed herein are for description and should not be regarded as limiting.

As such, those skilled in the art will appreciate that the conception, upon which this disclosure is based, may readily be utilized as a basis for the designing of other structures, methods, and systems for carrying out the several purposes of the present invention. It is important, therefore, that the claims be regarded as including such equivalent constructions as far as they do not depart from the spirit and scope of the present invention.

### BRIEF DESCRIPTION OF THE DRAWINGS

To describe the way the above-recited and other advantages and features of the invention can be obtained, a more particular description of the invention briefly described above will be rendered by reference to specific example embodiments thereof which are illustrated in the appended drawings. Understanding that these drawings depict only typical embodiments of the invention and are therefore not to be considered as limiting of its scope, the invention will be described and explained with additional specificity and detail using the accompanying drawings.

FIG. 1 is a perspective view demonstrating surgical preparation of an area to receive an implant.

FIG. 2 is a close-up view of the prepared area of FIG. 1.

FIG. 3 is a perspective view of an impression taken of an area prepared according to at least one embodiment of the invention.

FIG. 4 is a perspective view of an osseointegrable block of material before milling.

FIG. 5 is a perspective view of a restorative crown and an implant post milled from the osseointegrable block of FIG. 4.

FIG. 6 is perspective view depicting the insertion of the post of FIG. 5 into the area of FIG. 2.

FIG. 7 is a sectional view of the prepared area of FIG. 2, after post insertion.

FIG. 8 is a sectional view of the prepared area of FIG. 7, after osseointegration of the post.

FIG. 9 is a sectional view of the prepared area of FIG. 8, after placement of the restorative crown.

FIGS. 10A-10G are perspective views of alternate multi-axis, multi-anchored implant post designs.

FIG. 11 is a perspective view of an alternate embodiment of an implant post and restorative crown.

FIG. 12 is a close-up view of the implant post of FIG. 11, taken in circle XII.

FIGS. 13A-13C are further close-up views of alternate implant post deigns.

FIG. 14 is a perspective view of another embodiment of a multi-axis, multi-anchored dental implant.

FIG. 15 is a sectional view of the dental implant of FIG. 14.

FIG. 16 is a perspective view of a jaw before preparation using a

FIG. 17 is a perspective view of a prepared lower jaw before implantation.

FIG. 18 is a perspective view of the jaw of FIG. 16, after osteointegration of the implant and before affixation of the prosthetic.

FIG. 19 is a perspective and partial view of the jaw of FIG. 16, after osseointegration and addition of the ceramic prosthetic.

### DESCRIPTION

With reference now to the drawings, a preferred embodiment of the dental implant is herein described. It should be noted that the articles “a,” “an,” and “the,” as used in this specification, include plural referents unless the content clearly dictates otherwise.

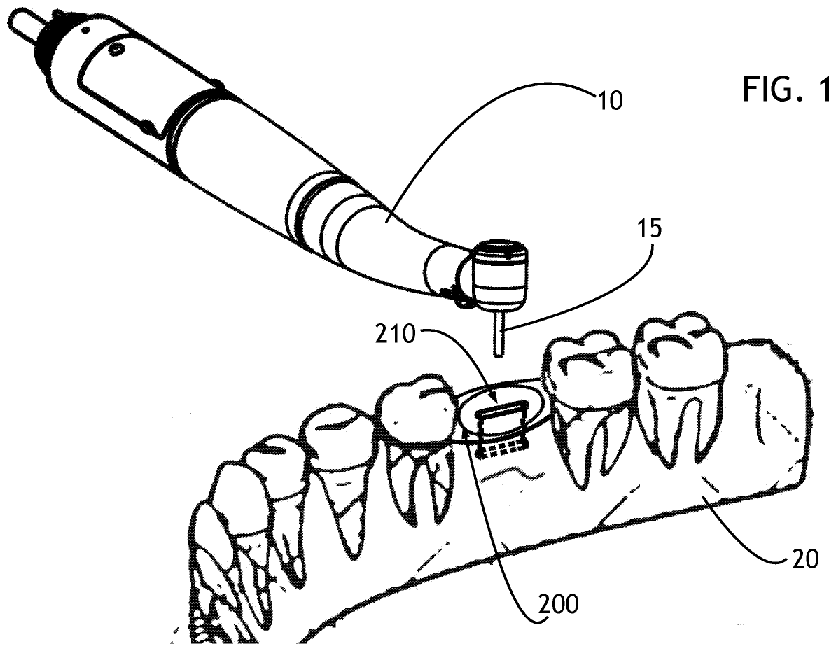

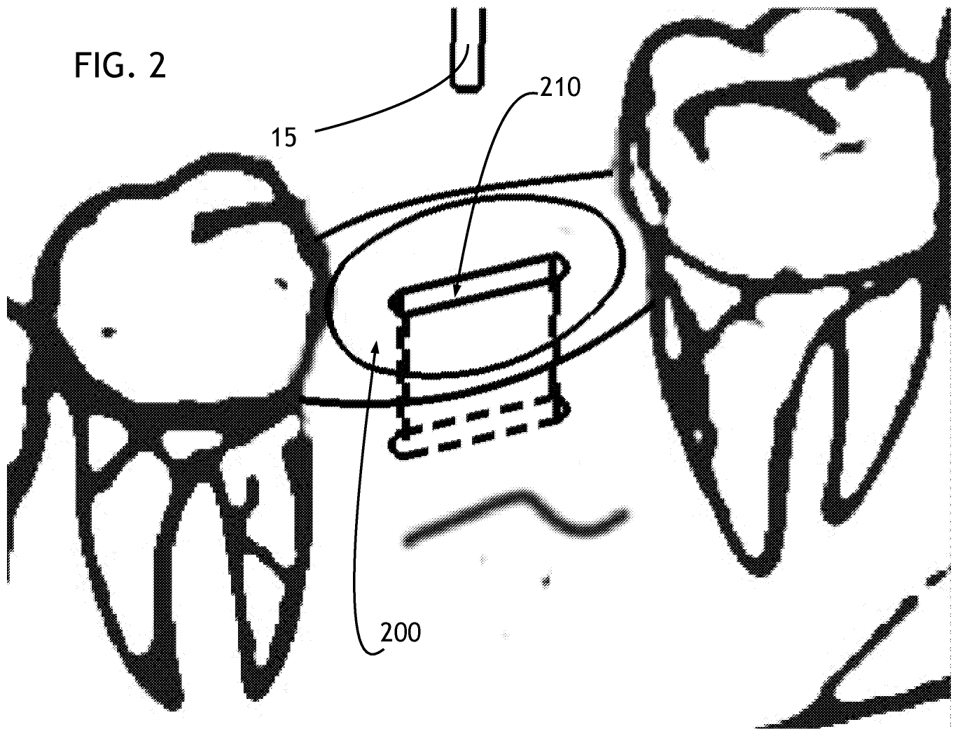

In reference to FIGS. 1 and 2, an area 200 is surgically prepared for receiving an implant. High speed handpiece 10 and attached cylindrical cutting bur 15 are utilized by the dental professional to excavate an implant retention slot 210 that is centrally located within structural bone 20 in a prepared area 220. The excavation of slot 210 is customizable for each patient as angle, depth and size are variable and are designed to be pre-planned prior to surgery, and ideally will maximize the surface area for osseointegration between adjacent teeth. Implant retention slot 210 is designed to frictionally retain the implant prosthetic during the healing and osseointegration process. When the treatment is complete, both slot 210 and prepared area 220 will become fully osseointegrated as an integral whole. Excavation of the slot will necessarily involve the removal of underlying bone tissue, as opposed to the mere removal of a diseased or dead tooth, which will necessarily leave an empty socket. Excavation will expand upon the socket by cutting adjacent bone.

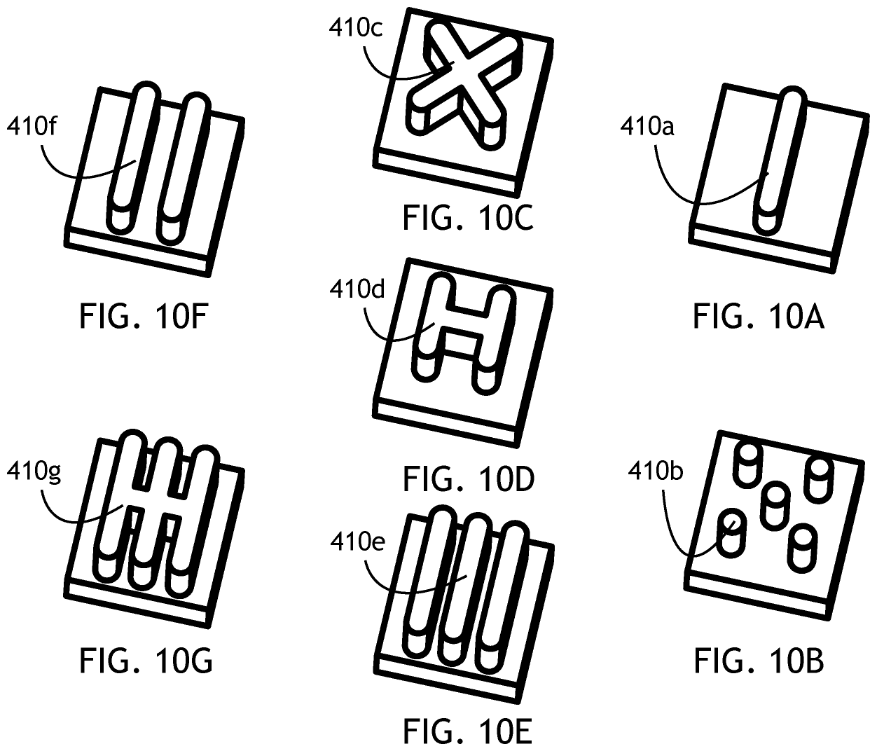

An embodiment of the present invention utilizes cutting bur 15 to create the various sizes, shapes, tapers, depths and especially widths that can be tailored for each patient. FIGS. 10A-10G show examples of various prosthetic implant fin designs (410a-410g) that can be manufactured by cutting different slot patterns in jawbone 20. The various slot patterns provide the professional with options to increase the retention of the prosthetic while it is osseointegrating. The best pattern will likely be chosen after the professional ascertains how much volume of bone is available with which to work. The practitioner may then remove additional soft tissue, with a scalpel, laser, or other implement, that is of a size and shape that corresponds to the external lateral dimensions of the final implant prosthetic, finishing the osseointegrable prosthetic implant area 220 which is designed to lie directly underneath the prosthetic that resembles a tooth. Any bleeding initiated by cutting slot 210 and area 220 may be arrested by means of haemostatic agents such as ferric sulfate, ferric chloride, aluminum chloride, aluminum sulfate, epinephrine and/or any haemostatic agent capable of slowing, constricting, clotting, or staunching the flow of blood.

A three-dimensional model of the treatment area must be made to form the custom implant. One manner to do this is to create a physical impression, a technique long practiced in the art. An impression of the treatment area may be taken, where FIG. 3 shows a material impression 300 taken of the treatment area of FIG. 1. As can be seen, the impression details of both slot 210 and area 220 are acquired. Material impression 300 may be generated by any materials and means known in the art or later discovered. Currently, impressions are generally created from a two-part mixed flowable material that hardens into a flexible elastomer over the course of a few minutes; usually a poly siloxane, poly ether, or other impression material. The two-part impression materials are mixed and appropriately placed in/over slot 210 and area 220 while it is in a flowable state and then removed when it becomes fully hardened, thus forming material impression 300. Material impression 300 is designed to retain an accurate rendering of the treatment area 200 of FIG. 1, which preserves the impression topography and details of implant retention slot 310 and exposed bone area 320, which are negatives of implant retention slot 210 and the exposed treatment area 220.

Material impression 300 is then scanned by means of an intra-oral camera, scanner, or other device such that via the collection of multiple images an accurate rendering of the impression is digitally recorded and through the utilization of CAD-CAM software a digital three-dimensional image is produced. The software then assists the practitioner in creating a three-dimensional digital model that is designed to fit into implant retention slot 210, exposed bone area 220, and may also digitally construct the remaining portions of the restoration that resembles a tooth.

As an alternative, if the practitioner possesses appropriate technology, then the slot and treatment area may be directly digitally scanned. This method forgoes the intermediate impression step and directly creates the digital model from the patient's mouth.

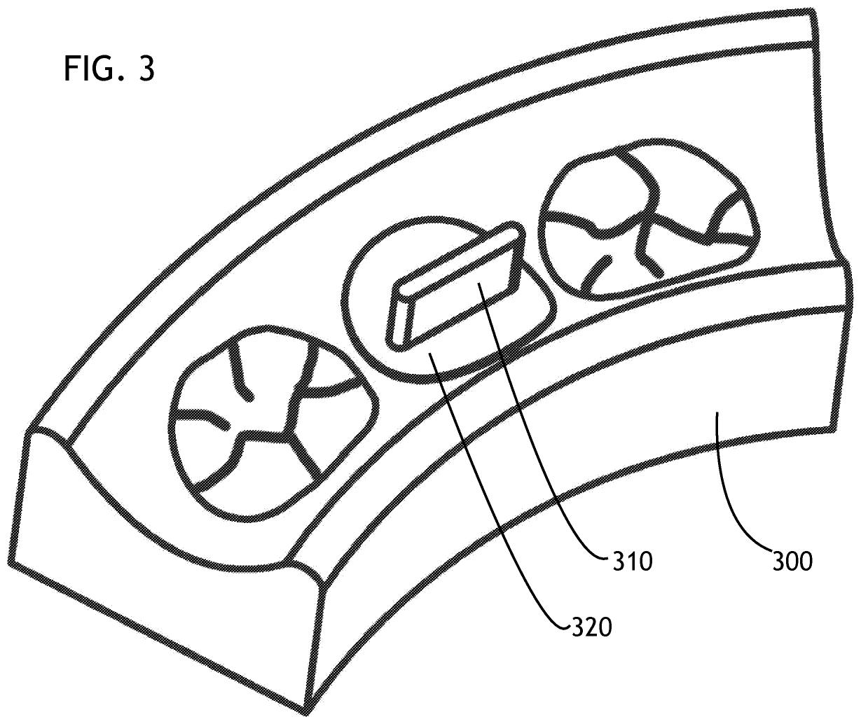

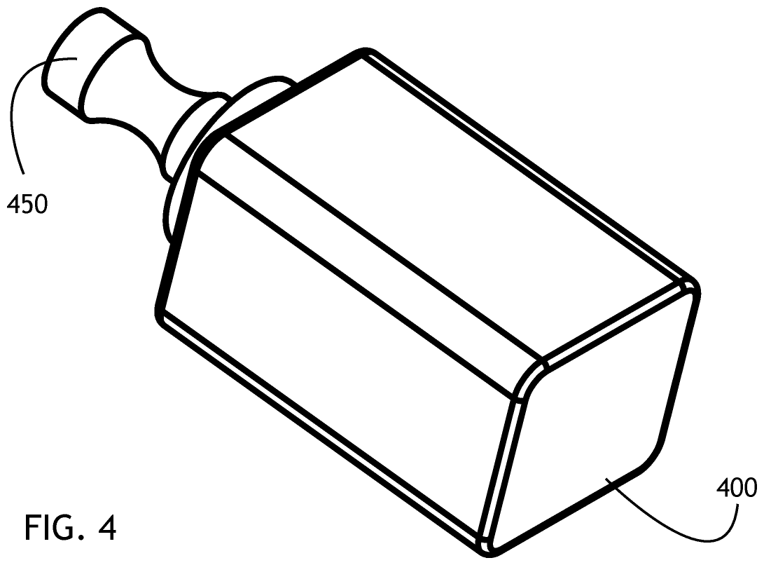

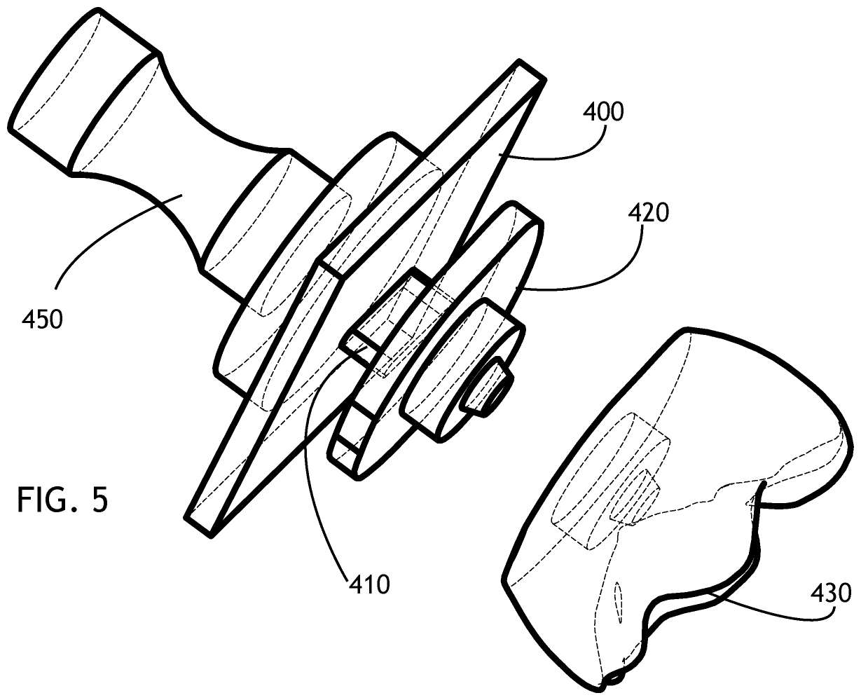

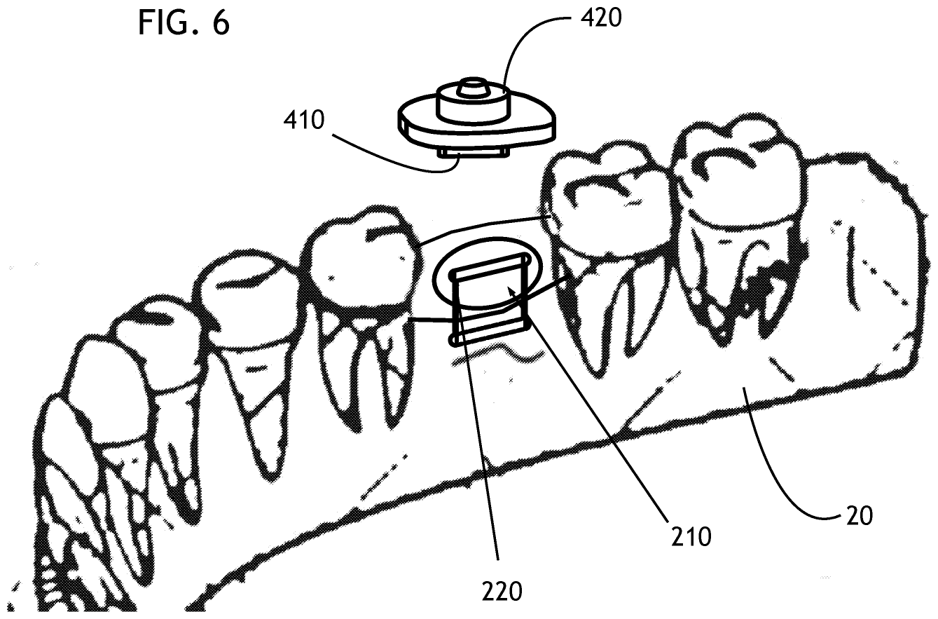

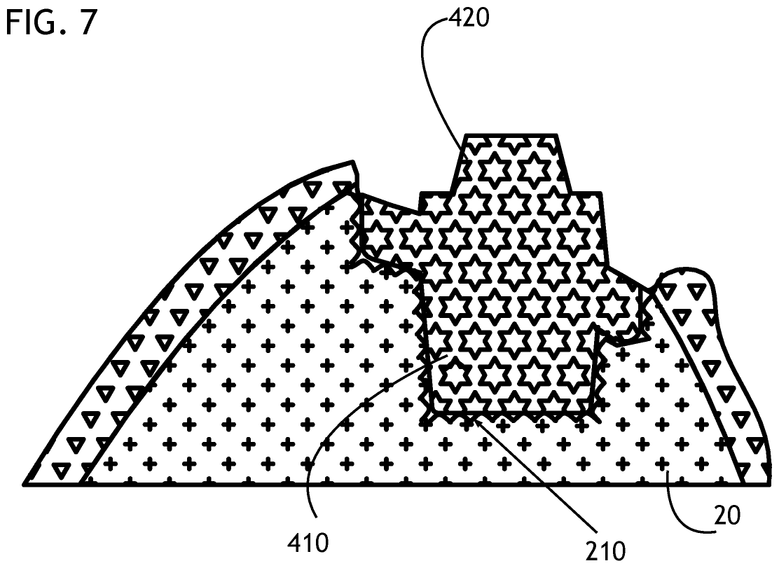

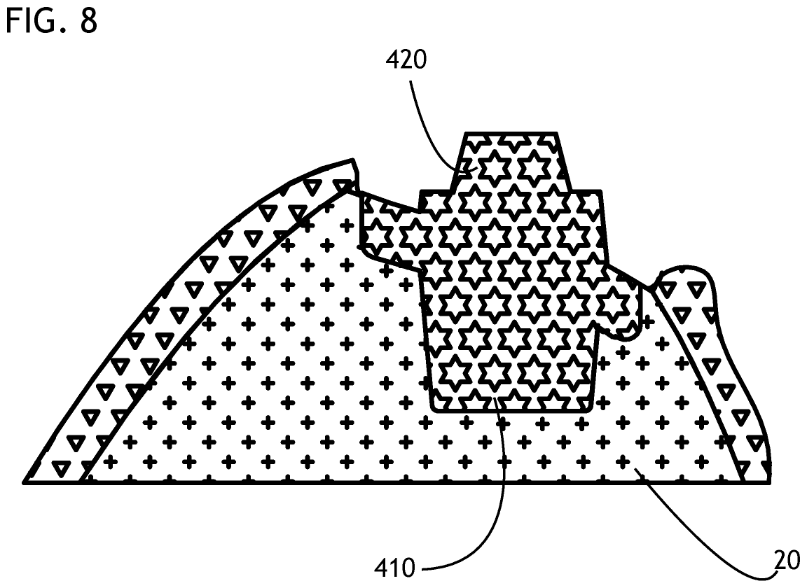

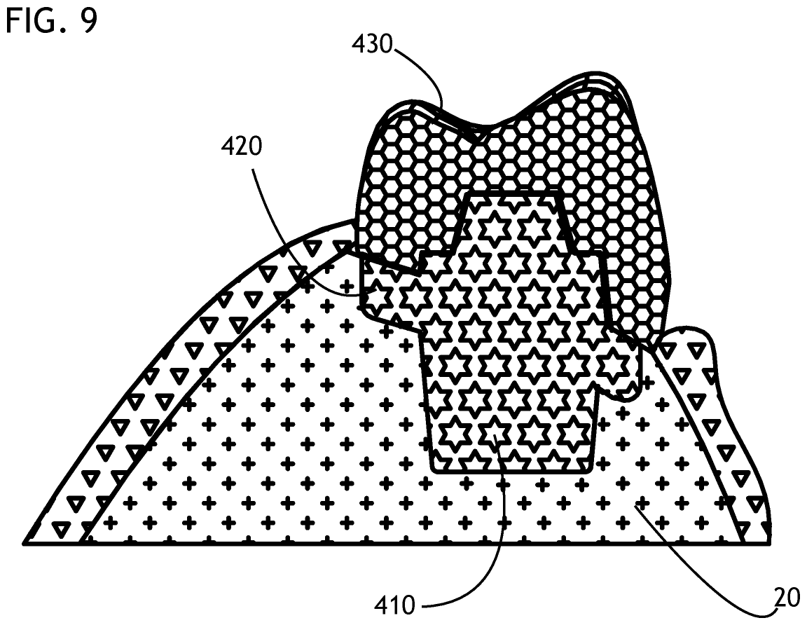

Once the three-dimensional digital modeling is complete, the image file of the model is uploaded to a CNC milling machine whereupon block holder 450 is installed into the operational chuck of said CNC milling machine. FIG. 4 depicts an embodiment of the present invention showing osseointegrable block 400 attached onto block holder 450. The CNC milling machine is then activated and with respect to the digital image file, the block 400 of osseointegrable material is cut, in a manner like that shown in FIG. 5. A retention implant post 420 and custom tooth crown restoration 430 are reproduced as the osseointegrable portion and cemented restorative portion of the implant prosthetic. It should be noted that the crown 430 may also be, instead, a temporary crown. Implant post 420 is designed with a fin 410 to be installed first into slot 210 until it is fully healed and osseointegrated, then the restoration is completed by permanently cementing in place the custom tooth crown restoration 430. While the crown restoration 430 is shown in FIG. 5 having been fashioned from the same osseointegrable block 400 as the implant post 420, it will not osseointegrate. Therefore, the crown may be fashioned from any number of other acceptable materials currently known or later discovered in the art. Nothing in the Specification should be read to require the crown restoration 430 and the implant post 420 to be made of the same material, though it may be convenient to fashion them during the same CNC session. Also note in FIGS. 6 and 7, the implant 420 alone is being installed in slot 210. Fin 410 imperfectly fits in slot 210 and the remaining portion of the implant 420 covers the prepared osseointegrable area 220. This strategy allows to the jaw 20 to heal and osseointegrate with the implant 420, both its main body and the fin 410 (FIG. 8), before placing the crown restoration 430. This prevents the implant 420 from being placed under the forces of occlusion because these repetitive forces are likely to interrupt the healing process. Thereafter, it is preferred to position the restorative portion 430 and cement it into place, which then does allow occlusion to occur (FIG. 9).

It is to be understood that the dimensions of retention post 420 and restorative portion 430 can be modified by way of the CAD CAM software; such that the fit can be altered to achieve a desired result. An example of an embodiment of this type of alteration is demonstrated by slightly enlarging retention implant post fin 410; such that when retention post 420 is inserted in retention slot 210 the fit is tight, and the retention of the finished prosthetic is maximized during the healing process. As discussed before, many fin designs are possible, including the multi-axis designs as shown in FIGS. 10A-10G, and may be utilized at the discretion of the practitioner. It is preferred to use a variety of shapes which do not necessarily conform to the root structure of the original tooth. Generic shapes are easier for a practitioner to generate and can be easily incorporated into guide forms, such as is later discussed. Generic shapes can also incorporate sufficient complexity to provide adequate anchoring of the implant and attached prosthetic without reliance on a single anchor post. Each unique design may impart a different hold of the implant 420 in the retention slot 210 and may promote healing and osseointegration. The practitioner would ideally decide based upon preference, available space and bone mass, and any other relevant consideration.

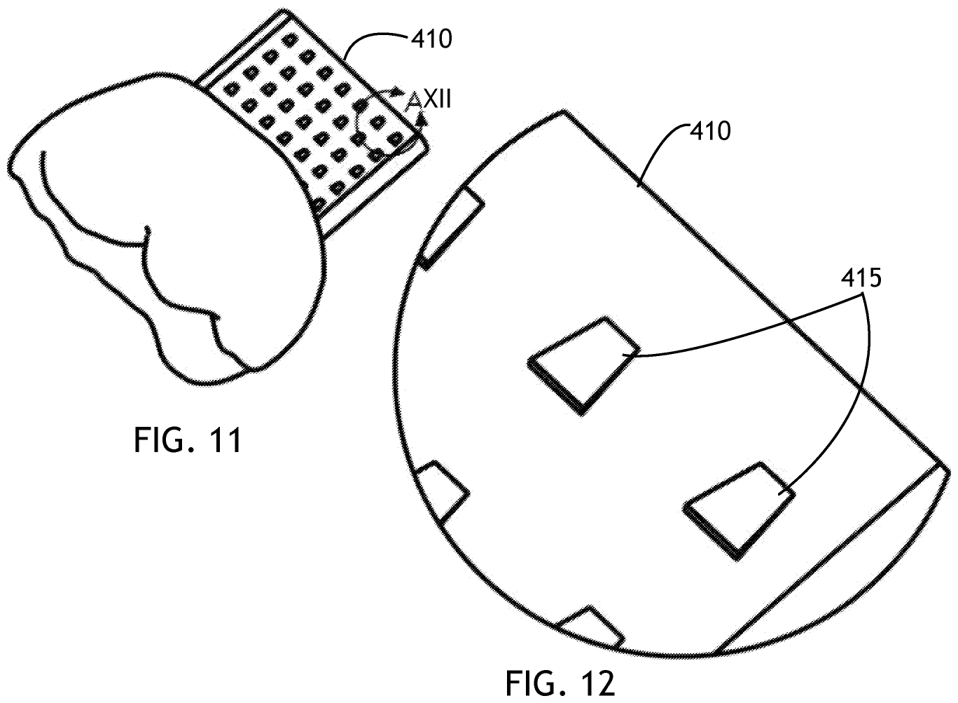

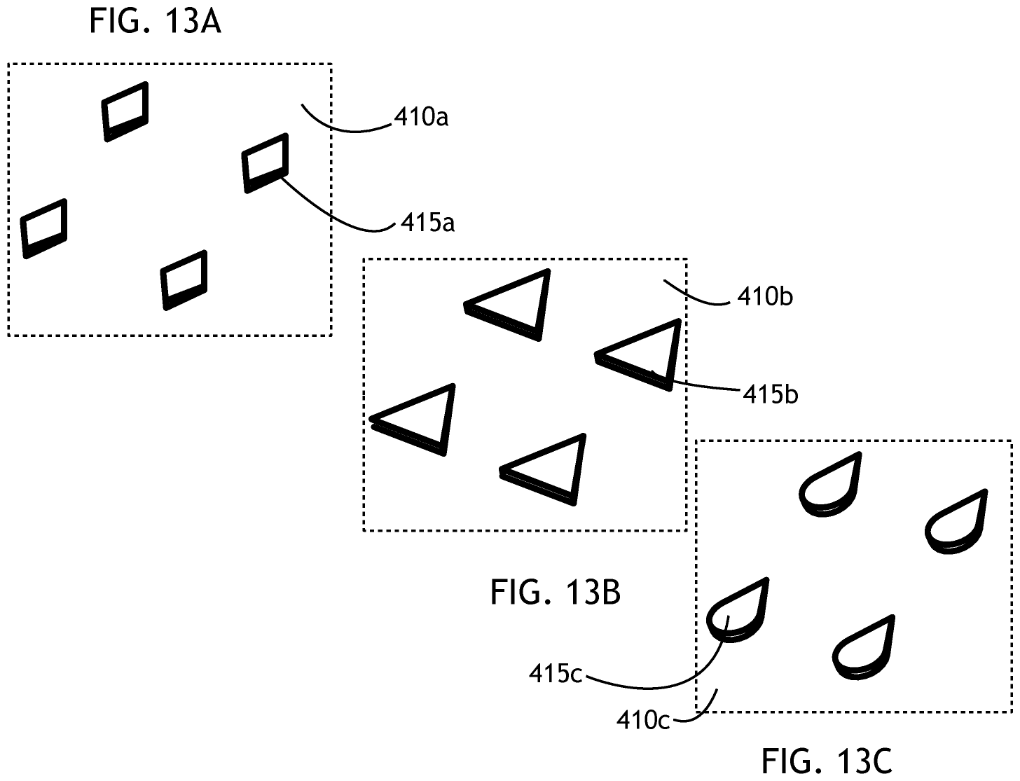

Another embodiment of the present invention, shown in FIG. 11, engraves protrusion friction marks 415 onto osseointegrable fin 415. Protrusion marks 415 are engraved by means of micro-milling, laser engraving or any other method capable of engraving fine detail. FIG. 12 is a close-up view of an embodiment of the present invention demonstrating an example of protrusion mark 415. Protrusion marks 415 are designed to minimize the force required to insert implant post 420 into retention slot 210; and at the same time maximize the retention by way of friction from any force that would attempt to pull the finished prosthetic from retention slot 210. It is preferred that protrusion marks 415 have a sloped configuration and are designed to minimize the force required to insert the finished implant prosthetic into retention slot 210. The downward slant of the slope should be in the direction of retention slot 210. Once installed, the prominent areas of protrusion marks 415 are forced against the bone of retention slot 210 and are designed to slowly embed themselves into the natural sponginess of natural bone to maximize retention. Other exemplary shapes of protrusion marks 415a, 415b, 415c, are shown in FIG. 13. The sloped friction marks have various shapes by design, such as rectangular, diamond, square, teardrop, triangular and any other shape that is designed to minimize the force required to insert the finished implant prosthetic into retention slot 210, and at the same time maximize the retention by way of friction from any force that would attempt to pull the finished prosthetic from retention slot 210.

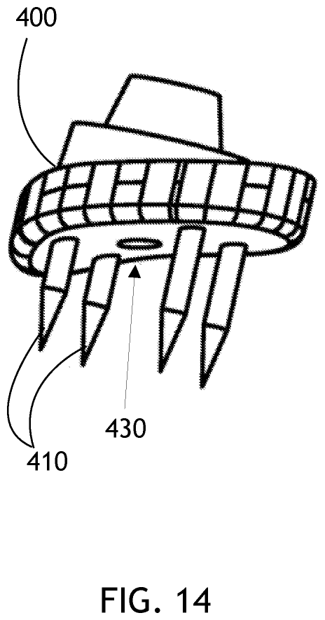

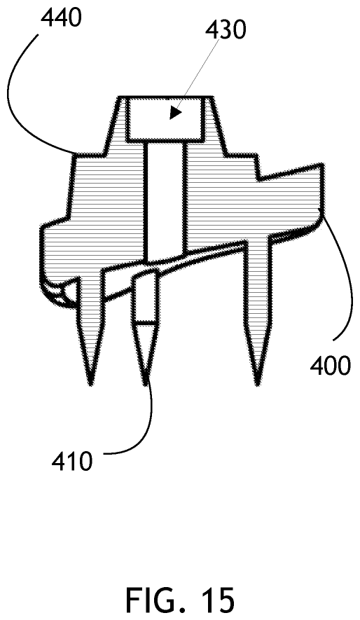

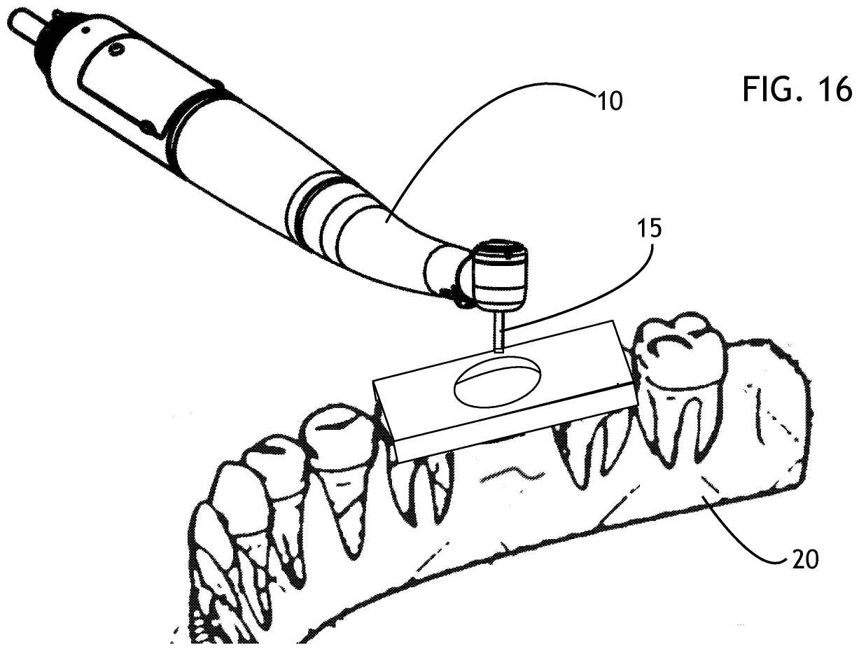

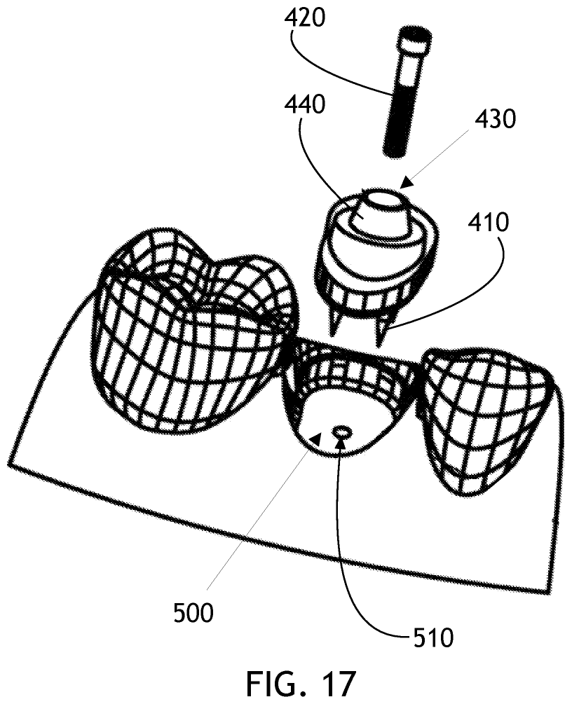

With reference to FIG. 14, an embodiment of a dental implant 400 following the teachings of the present invention can incorporate a multi-axis implant with four separate bone anchors 410. The use of four anchors is only exemplary and many other examples are possible that vary the size and shape of the implant and vary the number of bone anchors to at least two or more. Anchors may be discrete, as shown in FIG. 14, or may be integrated together as the fins shown in FIGS. 10A-10G. FIG. 14 shows a frontal view of the novel implant 400 while FIG. 15 shows a sectional view of the same. The dimensions and the shape implant 400 are maximized to approximate the tooth that has been replaced. In the disclosed embodiment, multiple pin, or spike bone anchors 410 are designed to be forced or pressed into bone to hold the implant firmly in place while healing and osseointegration ensues. One embodiment of the present invention will utilize implant screw 420 to drive the spiked bone anchors 410 into the bone during the implant procedure. This process is done using the force provided when implant screw 420 is screwed into place, usually with a calibrated ratchet. This implant screw 420 then serves as an additional anchor. The position, size, length, and sharpness of spiked bone anchors 410 can be varied dependent upon each individual case. The most preferred position of bone anchors 410 is out on the edge of the dental implant, forming a right angle with implant 400 such that it only has one way to fit into a cut bone-box 500 (FIG. 17) such that the sides of each bone anchor 410 barely fit into the cut box 500 and only fit into the box oriented in one way. This design is intended to help the dental professional easily seat the implant in the correct position while minimizing the chance of implant wiggle-room.

Implant screw 420 is housed in a channel 430 within the multi-axis, multi-anchor implant 400 with the preferred position of the channel being in the center or centrally placed within the implant. Channel 430 is designed to locate and house implant screw 420 and it is through this slot the implant is held firmly in place during osseointegration. Channel 430 as depicted is designed to generally house screw-type implant bone anchors and more than one of this type of bone anchors are possible within any implant of the present invention, so the use of a single channel 430 should not be seen as limiting.

The portion of the implant that is located above bone is the prosthetic attachment post 440 and is designed and is of a shape to receive the permanent tooth prosthetic 450. The shape of prosthetic attachment post 440 is usually a tapered prep that is designed to receive a cemented prosthetic such as a crown or bridge.

FIG. 16 shows the implantation process of one of many possible examples of the present invention. The first step is to excavate a “bone box” in the jaw bone as demonstrated by bone box 500. The dimensions of box 500 are intended to maximize the osseointegration area between the adjacent teeth and is of a depth such that when seated into place, the main upper surface of the implant 400 will be flush with the surface of the bone. The box 500 can be excavated with a highspeed handpiece utilizing diamond or carbide burs wherein the length of the cutting portion of the bur is the correct depth by design, such that the dental or medical professional can easily determine the required depth of the box 500. In a more sophisticated procedure, a custom plastic guide 600 can be manufactured utilizing a cone beam to determine the anatomical dimensions of said guide 600. The custom guide 600 is designed to form fit over the healthy teeth leaving a precise-dimension box pattern between the healthy teeth so a highspeed handpiece may be used in making a bone box 500 of not only appropriate surface area, but also depth. In this manner, the dentist may use a burr set at the correct length and need only place the handpiece flush with the insert 600 to cut a precise slot or box of correct surface area and depth. While the bone box 500 may be of any ultimate dimensions, the key aspects with respect to the invention is that the surface area, and thus the osseointegration area, is maximized to an extent allowable by the anatomy of the patient and that the bone box 500 present a relatively uniform lower surface into which the bone anchors 410 will pierce and osseointegrate, though the ultimate uniformity of the bottom surface will also be dependent upon the patient's anatomy.

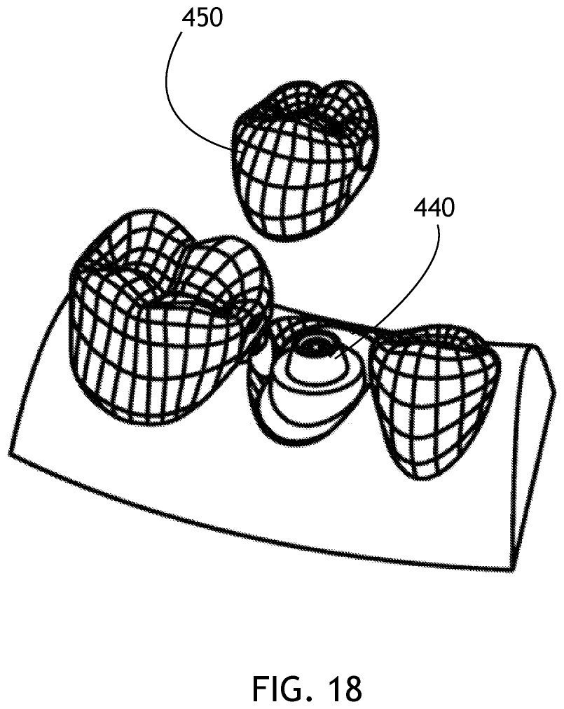

The second step of the implantation process, shown in FIG. 17, is to place the multi-axis, multi-anchor implant 400 aligned into the box 500. Ideally this second step is performed before the bone box 500 has had a meaningful chance to heal because osseointegration occurs during the bone healing process. The implant 400 is manufactured to the specifications of the bone box 500 such that it has a surface area commensurate with the surface area of the bone box 500 and has a height sufficient to support the final prosthetic 450 (FIG. 18). The preferred method of alignment is to design the bone anchors 410 to fit only one way and without significant wiggle room when initially placing the implant 410 such that alignment is automatic. Using a conventional drill and using the implant as a secondary guide, a pilot hole 510 for implant screw 420 is drilled into the bone to an appropriate length. Thereafter, the implant is forcefully seated into place utilizing the force produced when driving implant screw 420 into place with a calibrated ratchet or wrench. In this manner, a single pilot hole is drilled for the implant screw 420, but the use of screw 420 allows the anchors 410 to pierce and force their way into the lower surface of the bone box 500 and create the multiple anchor points without time consuming formation of more complex slots. The seated implant and bone box 500 are then allowed to osseointegrate together.

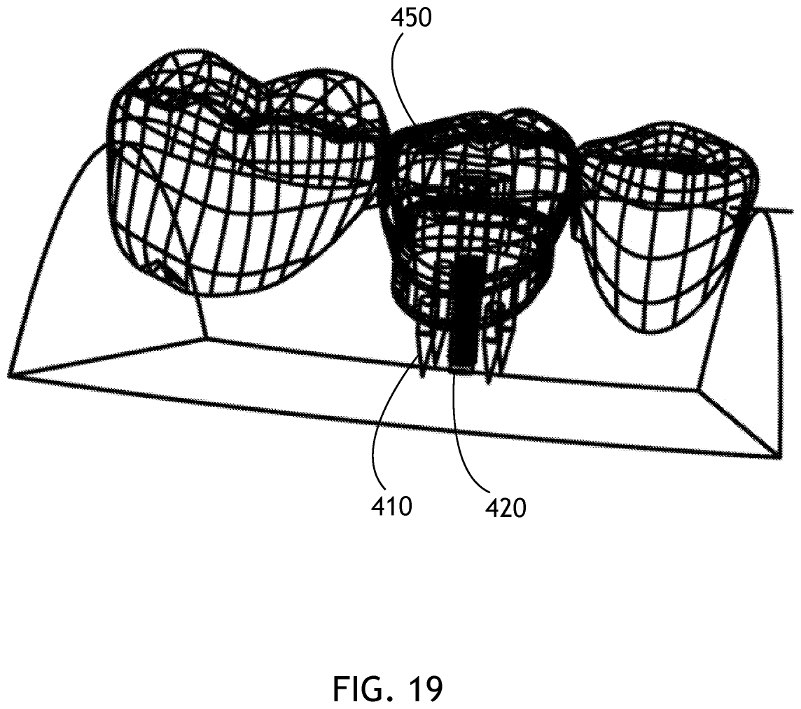

After osseointegration is complete, a prosthetic crown 600 may be cemented onto implant post 440 (FIG. 18). Conventional cements and adhesives may be used to secure the prosthetic is permanently into place. This then leaves the implant 400 and prosthetic 600 in a finished state (FIG. 19).

There are multiple methods and means of manufacturing the implant. A preferred method is the production of a custom implant. This method requires the dentist to radiographically scan the treatment area, such that a three-dimensional digitized file of the bone anatomy is produced. The file is sent to a dental lab where the file is uploaded and, after review, a treatment plan is customized to the patient. The shape and dimension of a custom implant is devised to best fit the bone anatomy of each patient wherein this review will enable practitioners to pre-determine the size, shape, and depth of bone box 500. The custom implant is first created digitally by means of software such as CAD-CAM and then it is sent to a CNC milling machine, laser sintering unit, lost wax metal casting or other method of metal reproduction to produce the final custom implant. With the same digital file, a custom plastic insert 600 can be fabricated to precisely guide the dentist during the removal of bone when cutting bone box 500, so that the multi-axis, multi-anchor implant has a precise fit with minimal wiggle room.

Another method of manufacturing is the production of various standardized sizes of implants that are designed to approximate the fit of each tooth number individually. This requires the production of many prefabricated sizes. The dentist would simply select the nearest size that best fits the individualized anatomy of the patient, using free-hand technique, a surface template imprint, and a known cutting depth determined by the length of the cutting portion of the bur would cut bone box 500 as best as possible. Though this procedure would not be as accurate as a custom implant, it is still feasible since bone will fill in slightly larger gaps anyway. In this event, osseointegration would only take additional time.

The present invention utilizes any element that is capable of osseointegration, especially those elements or compounds that form strong durable structures. Materials such as titanium, titanium alloys, titanium ceramics, zirconium, zirconium alloys, zirconium alloys, and any like materials are all within the scope of the present invention; especially the titanium alloy: Titanium/6 Aluminum/4 Vanadium.

Although the present invention has been described with reference to preferred embodiments, numerous modifications and variations can be made and still the result will come within the scope of the invention. The described embodiments are to be considered in all respects only as illustrative and not restrictive. No limitation with respect to the specific embodiments disclosed herein is intended or should be inferred. Therefore, the scope of the invention is indicated by the appended claims rather than by the foregoing description. All changes which come within the meaning and range of equivalency of the claims are to be embraced within their scope.

What is claimed is:

1. A method of providing a dental implant, the method comprising:
preparing an implant surface area by removing soft tissue and exposing underlying jawbone tissue such that the exposed jawbone tissue has a surface area that is maximized between bordering healthy teeth;
cutting a bone box having a set depth within the jawbone tissue, the bone box occupying the maximized surface area;
providing a customized implant with a surface area commiserate with the maximized surface area, the insert having a plurality of bone anchors;
setting the implant within the bone box using an implant screw such that the plurality of bone anchors is driven into and pierces a lower surface of the bone box; and,
allowing the implant to osseointegrate with the underlying jawbone tissue.

2. The method of claim 1, further comprising preliminary steps of:
creating a digital model of at least a portion of an oral cavity;
using the digital model to create a customized implant that maximizes osseointegration area;
using the digital model to create a guide for fashioning a bone box to receive the customized insert; and
positioning the guide within the oral cavity as a preliminary step to prepare the implant surface area.
